(19) United States
(12) Patent Application Publication
(10) Pub. No.: US 2015/0032646 A1
(43) Pub. Date: Jan. 29, 2015

(54) SYSTEM AND METHOD FOR ENSURING REASONABLE HOUSING ACCOMMODATION

(71) Applicants: Michael John Mirra, Tacoma, WA (US); Todd Richard Craven, Auburn, WA (US); Daniel Joseph Clark, Bothell, WA (US)

(72) Inventors: Michael John Mirra, Tacoma, WA (US); Todd Richard Craven, Auburn, WA (US); Daniel Joseph Clark, Bothell, WA (US)

(21) Appl. No.: 14/512,077

(22) Filed: Oct. 10, 2014

Related U.S. Application Data
(63) Continuation of application No. 14/027,951, filed on Sep. 16, 2013.
(60) Provisional application No. 61/701,557, filed on Sep. 14, 2012.
(60) Provisional application No. 61/701,554, filed on Sep. 14, 2012.

(51) Int. Cl. G06Q 30/00

(52) U.S. Cl. CPC G06Q 30/018; G06Q 50/163
USPC 705/314

(57) ABSTRACT

A system includes at least one processor and at least one storage device in communication with the at least one processor. The at least one storage device includes instructions that, when executed by the at least one processor, enable the performance of a method including the steps of generating to a display device a graphical user interface comprising elements enabling at least one user to enter alphanumeric data and responses to questions presented within the user interface; presenting within the user interface an interview comprising a set of questions that are based on a set of requirements of at least one government regulation; generating, based on responses to the set of questions received from the at least one user, a decision on whether to grant a government-provided benefit to a potential recipient of said benefit; and updating a database with the responses provided by the user.

### CROSS-REFERENCE TO RELATED APPLICATIONS

The present application is a continuation of U.S. application Ser. No. 14/027,951 filed Sep. 16, 2013, which claims priority from U.S. Provisional Applications Nos. 61/701,557 and 61/701,554, each of which was filed Sep. 14, 2012. Each of the aforementioned applications is hereby incorporated by reference as if fully set forth herein.

### COPYRIGHT NOTICE

This disclosure is protected under United States and International Copyright Laws. © Tacoma Housing Authority. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BRIEF DESCRIPTION OF THE DRAWING

Preferred and alternative embodiments of the present invention are described in detail below with reference to the following drawing figures.

FIG. 1 is a schematic view of an exemplary operating environment in which an embodiment of the invention can be implemented;

FIG. 2 is a functional block diagram of an exemplary operating environment in which an embodiment of the invention can be implemented;

FIGS. 3A-5 depict flow diagrams illustrating at least one method according to at least one embodiment of the invention.

### DETAILED DESCRIPTION OF THE PREFERRED EMBODIMENT

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

An embodiment tracks reasonable accommodation requests from users on behalf of applicants for government-funded housing accommodations. The embodiment offers suggestions and has certain restrictions in place to help ensure the user does not make a decision that is in conflict with regulations governing approval of such requests.

When a user logs into the system to process a new reasonable accommodation (RA) request, they will first create a new case. This action prompts the user to enter all the client data and asks them a number of important default questions based on statutory/regulatory qualification requirements. Questions are setup in the custom database, and the administrative users can add additional questions and dependencies. However, the default questions cannot be changed, as the system will use the answers to these questions to allow the case to move on or to stop it at the first level. In an embodiment, the default questions are:

Is the request on behalf of a disabled person?

Is the requested accommodation, for reasons related to the disability, necessary to allow the full enjoyment of the premises?

Is the request reasonable?

Can request be afforded without an undue financial burden?

Can request be granted without an undue administrative burden?

Can request be granted without fundamentally altering a person's job or program?

The questions may be answered using YES, NO, or UNDETERMINED. If any of the answers to the questions are NO, the logic in each level of the program changes their approval to DENY.

The same default questions may be asked by a Level 1 staff person, a Level 2 (their supervisor), and a Level 3 (Review Committee) before the request is sent to the Compliance Coordinator.

The Compliance Coordinator reviews the recommendation by each of the three levels and makes a ruling of Approved, Approved with Modifications, Denied, or Withdrawn.

Each level can “Return” the request to any previous level asking for more information. Confidential emails can also be recorded and forwarded through the application.

There are four roles in an embodiment, all of which are entirely customizable. However, it is recommended to use at least two levels of approval to ensure the integrity of the process. The four roles are: Level 1 approver (staff), Level 2 approver (supervisor), Review Committee, and Compliance Coordinator. In an embodiment, programmed policy rules state new requests (pending investigation) have 10 days to complete the process and send to the next level. Requests at Level 2 have 5 days to make a decision and send to the next level. Requests where the Level 1 and Level 2 disagree are then sent to the Review Committee status, which has 30 days to make a recommendation to the Compliance Coordinator. These rules may also be customized depending on the policy of the particular agency.

In an embodiment, once a request has been entered and approved by all required levels, it enters a status called “Pending Implementation”. After the request is implemented, it can be assigned a status of “Active Reviewable”. Active Reviewable Requests are reviewed each year and this process is also controlled by the request system according to an embodiment.

In an embodiment, the system generates reminder notifications weekly to all the parties with overdue or outstanding requests. An embodiment may use a customer's Active Directory login if they choose to connect the database to their local company network.

In an embodiment, a system contains an administrative section where administrators can setup user access and privileges depending on the role they are assigned. For agencies utilizing the system for tracking requests from their own employees, there is also a Human Resources role that allows access to the employee requests.

In an embodiment, a system guides staff through difficult policy questions in a structured way and does not allow them to give the wrong answer or conflicting answers. The system asks six qualifying yes/no policy questions and will automatically deny the request for a reasonable accommodation if the user answers “no” to any of them. If all questions are answered “yes”, the system will approve the request and will send it to the next level. As long as the staff member completing the online form has enough information about the client, the request, and the case to answer the questions truthfully, and does answer them truthfully, the system will be able to correctly determine whether to approve or deny the request based strictly on policy.

An embodiment controls the number of people who look at review requests so one person does not make decisions regarding reasonable accommodation requests on their own. An embodiment presents questions that bring consistency to the decision-making process. The answers to all past questions are stored and reported on.

Once the user answers “yes” to a request, the system ensures that the decision is followed by requiring the user to enter information documenting the implementation of the request within a particular timeframe.

An embodiment provides an internal policy and a system to help ensure they follow the policy. If followed, the policy will protect the agency from making poor, inconsistent decisions regarding requests. An embodiment provides a written record of what decisions were made and why such can be used in a defense, if necessary.

By disabling the user from altering the set of questions, an embodiment prevents people from manipulating an agency's request policy or procedure in order to obtain a request. If the request is denied, an embodiment will suggest other options to help the client.

An embodiment gives discipline to the tone of the process, especially in case of a denial. This is controlled by automatically generated forms and letters to clients that are created and saved in an embodiment by an administrator.

Additionally, an embodiment may be implemented in a web-based software application and SQL database.

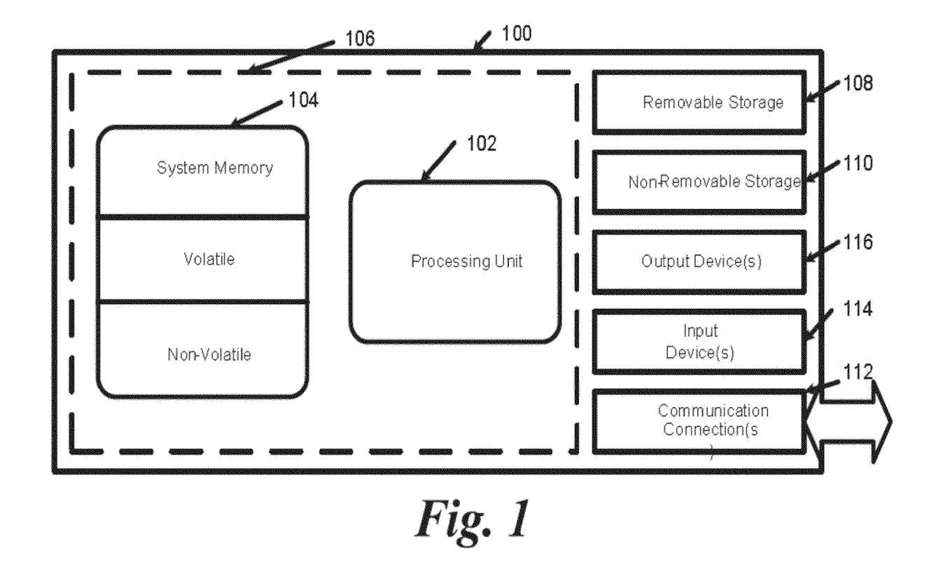

FIG. 1 illustrates an example of a computing system environment 100 in which an embodiment of the invention may be implemented. The computing system environment 100, as illustrated, is an example of a suitable computing environment; however it is appreciated that other environments, systems, and devices may be used to implement various embodiments of the invention as described in more detail below.

Embodiments of the invention are operational with numerous general-purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Embodiments of the invention may be described in the general context of computer-executable instructions, such as program modules being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed computing environment, program modules may be located in both local and remote computer storage media including memory storage devices.

With reference to FIG. 1, an exemplary system for implementing an embodiment of the invention includes a computing device, such as computing device 100. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

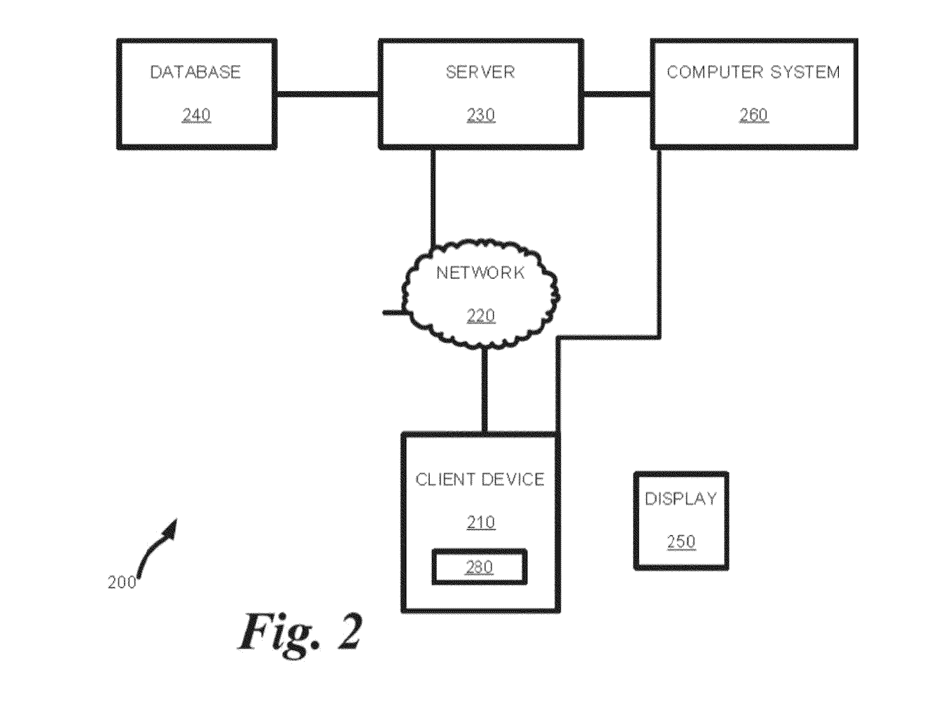

Referring now to FIG. 2, an embodiment of the present invention may take the form, and/or may be implemented using one or more elements, of an exemplary computer network system 200. The system 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

The client device 210 and the server 230 may include all or fewer than all of the features associated with the device 100 illustrated in and discussed with reference to FIG. 1. The client device 210 includes or is otherwise coupled to a computer screen or display 250. The client device 210 may be used for various purposes such as network- and local-computing processes.

The client device 210 is linked via the network 220 to server 230 so that computer programs, such as, for example, a browser, running on the client device 210 can cooperate in two-way communication with server 230. The server 230 may be coupled to database 240 to retrieve information therefrom and to store information thereto. Database 240 may include a plurality of different tables (not shown) that can be used by the server 230 to enable performance of various aspects of embodiments of the invention. Additionally, the server 230 may be coupled to the computer system 260 in a manner allowing the server to delegate certain processing functions to the computer system. In an embodiment, the client device 210 may bypass network 220 and communicate directly with computer system 260.

Still referring to FIG. 2, and in operation according to an embodiment of the invention, a user (not shown) of the client device 210 desiring to benefit from features of an embodiment may use a browser application running on the client device to access web content, which may, but need not, be served by the server 230. Specifically, by employing an appropriate uniform resource locator (URL) in a known manner, the user may download from the server 230 and install on the client device 210 a user interface module 280 comprising computer-executable instructions as described more fully hereinafter. Alternatively, the user may receive the module 280 on a tangible computer-readable medium (not shown), such as, for example, a CD-ROM, and subsequently install the module on the client device 210 from the medium.

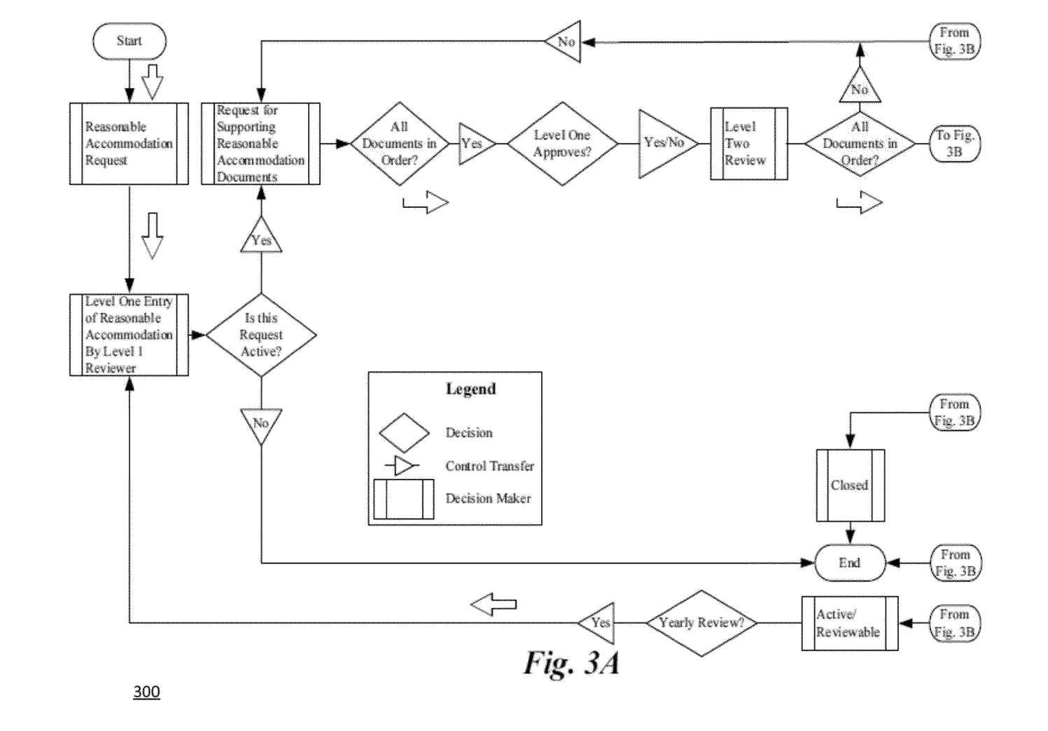

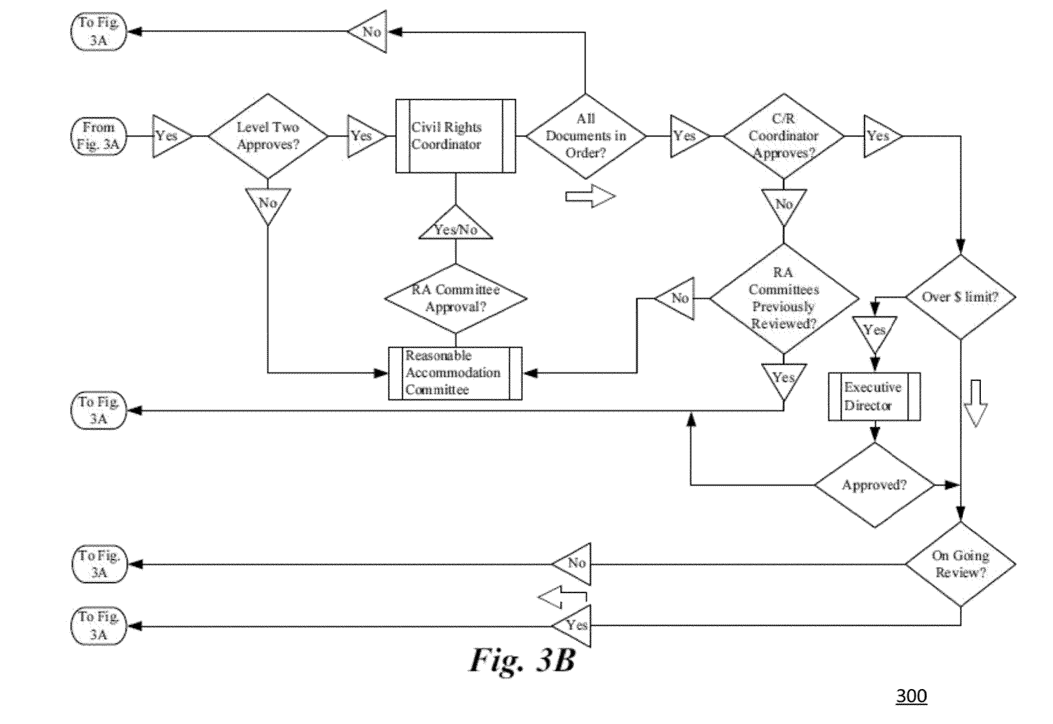

Upon executing the module 280, one or more users may electronically perform a method, at least one embodiment of which is illustrated in FIGS. 3A-5 and that is discussed in greater detail below. In performing such methods, the one or more users may invoke on display 250 one or more of the images illustrated in Appendix A of U.S. application Ser. No. 14/027,951.

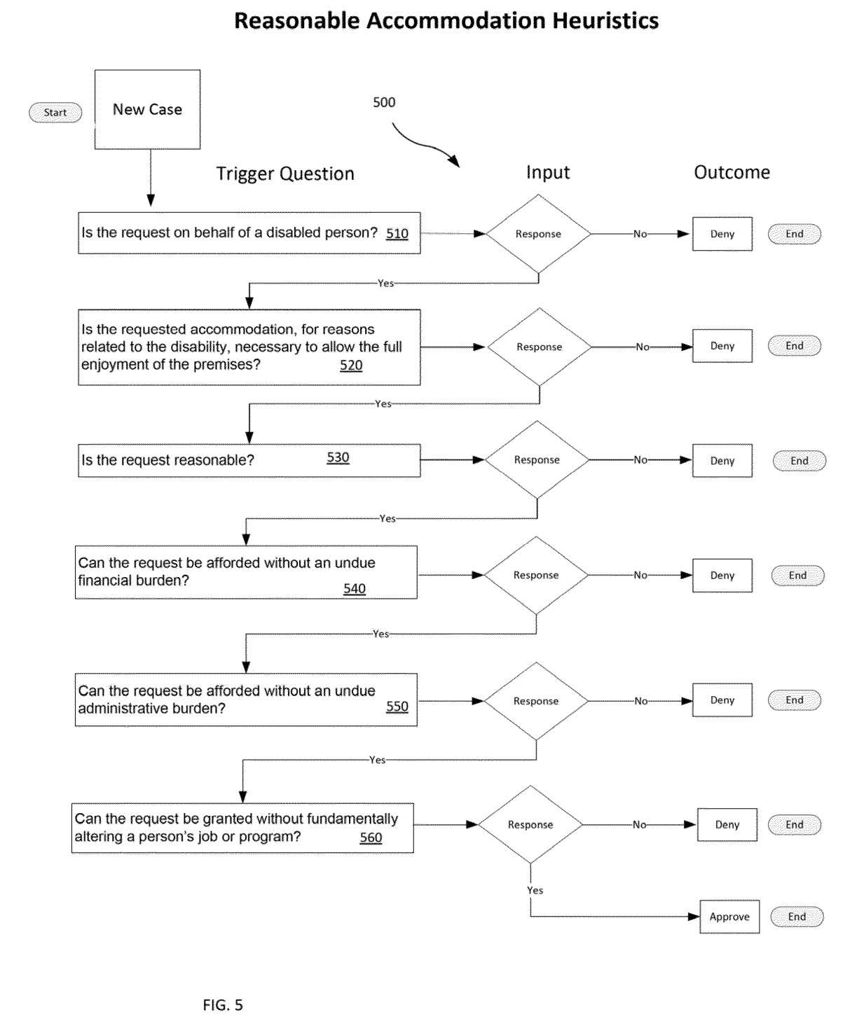

In an embodiment, a processing device, such as that associated with server 230, computer system 260 and/or client device 210, is configured to perform a method described in further detail below, particularly with reference to FIG. 5.

As is discussed in the aforementioned Appendix A, and as will be discussed in greater detail below, FIGS. 3A-3B illustrate in flowchart form a process of hierarchical evaluation, using an interview process presented within a graphical user interface, of a reasonable accommodation request according to an embodiment.

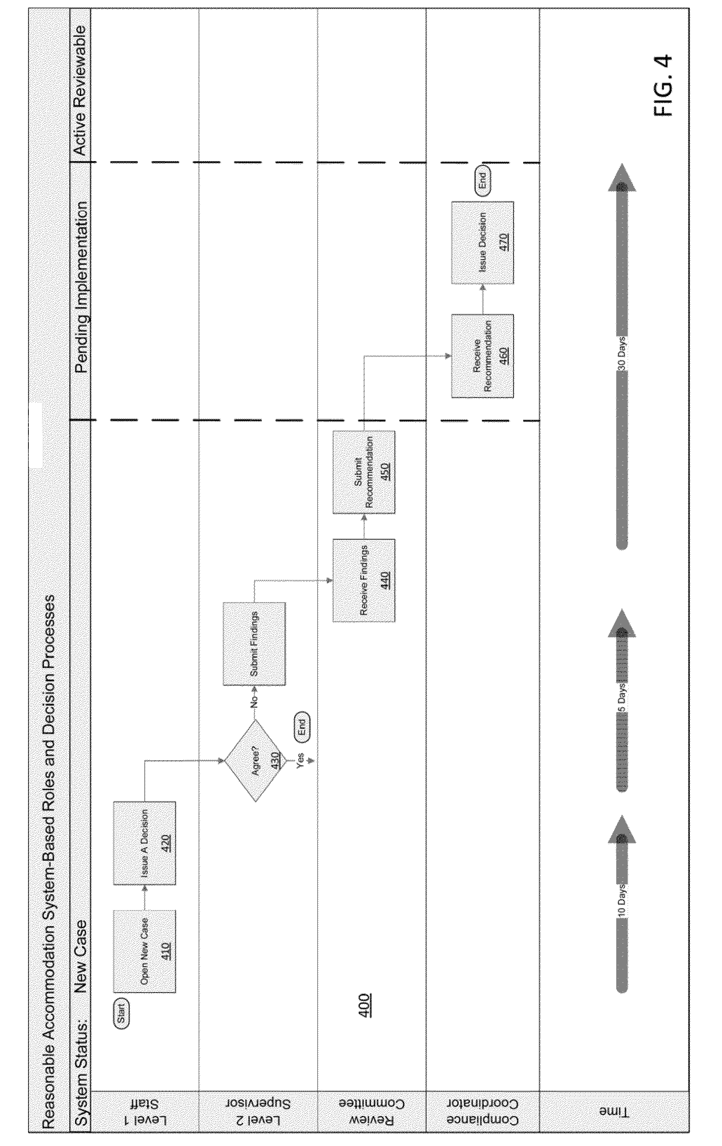

As is also discussed in the aforementioned Appendix A, and will be discussed in greater detail below, FIG. 4 illustrates in the flowchart/timeline form a process of hierarchical evaluation, using an interview process presented within a graphical user interface, of a reasonable accommodation request according to an embodiment. Generally speaking, the evaluation process commences at a block 410 with a Level 1 staff member opening a new case for evaluation. Such a case may involve, for example, a benefit including a subsidized modification of housing to accommodate a disabled individual (i.e., requesting party).

At a block 420, the Level 1 staff member, by employing an interview process discussed in greater detail below with reference to FIG. 5, arrives at a decision with regard to the request. The case evaluation then proceeds to review by a Level 2 supervisor.

At a block 430, the Level 2 supervisor may likewise employ the aforementioned interview process to arrive at his or her own decision with regard to the request. If the supervisor agrees with the assessment of the Level 1 staff member, the request is approved. Otherwise, the supervisor submits his or her findings to the review committee.

At a block 440, the review committee may employ the aforementioned interview process to arrive at its own decision with regard to the request. At a block 450, the review committee's assessment is submitted to the compliance coordinator.

After receiving the review committee's assessment at a block 460, the compliance coordinator, at a block 470, issues its final decision in connection with the request.

With regard to the aforementioned interview process, a graphical user interface, such as may be associated with module 280, is generated to a display device, such as display 250. The user interface includes elements enabling at least one user, such as one or more users associated with Level 1, Level 2 and/or the Review Committee as alluded to in FIGS. 3-4, to enter alphanumeric data and responses to questions presented within the user interface.

An interview comprising a set of questions that are based on a set of requirements of at least one government regulation is presented to the at least one user within the user interface. For example, the interview questions may track or otherwise reflect a set of specific criteria set forth in the language of a regulation governing the grant of a reasonable accommodation request. An example of requirements that must be specifically met pursuant to the explicit language of a governing regulation is set forth in the following discussion of FIG. 5.

FIG. 5 illustrates a process 500 according to an embodiment of the invention. The process 500 is illustrated as a set of operations shown as discrete blocks. The process 500 may be implemented in any suitable hardware, software, firmware, or combination thereof. The order in which the operations are described is not to be necessarily construed as a limitation.

At a block 510, the user is asked whether the request is on behalf of a disabled person. If the response to the question is no, then the request is denied. Otherwise the interview proceeds to block 520.

At block 520, the user is asked if the requested accommodation, for reasons related to the disability, is necessary to allow the full enjoyment of the premises. If the response to the question is no, then the request is denied. Otherwise the interview proceeds to block 530.

At block 530, the user is asked if the request is reasonable. If the response to the question is no, then the request is denied. Otherwise the interview proceeds to block 540.

At block 540, the user is asked if the request can be afforded without undue financial burden on the requesting party. If the response to the question is no, then the request is denied. Otherwise the interview proceeds to block 550.

At block 550, the user is asked if the request can be afforded without an undue administrative burden on the granting agency. If the response to the question is no, then the request is denied. Otherwise the interview proceeds to block 560.

At block 560, the user is asked if the request can be granted without fundamentally altering a person's job or program. If the response to the question is no, then the request is denied. Otherwise the request is approved by the particular user subject to the assessment of a higher-level user, if any.

Based on responses to the set of questions received from the at least one user, a decision may be generated by the processing device on whether to grant a reasonable accommodation request (i.e., a government-provided benefit) to a potential recipient of said benefit.

A database, such as database 240, is updated with the responses to the interview questions provided by the user, as well as by subsequent users. Consequently, once elements of the system 200 have accumulated historical data, such elements can provide information including, for example, number of approved past requests of a similar nature, the average cost associated with a specific type of past request, and/or the dollar cutoff historically governing whether a request was approved or denied.

While the preferred embodiment of the invention has been illustrated and described, as noted above, many changes can be made without departing from the spirit and scope of the invention.

What is claimed is:

1. A computer-readable medium on which are stored instructions that, when executed by a processing device, enable the processing device to perform a method comprising the steps of:
generating to a display device a graphical user interface comprising elements enabling at least one user to enter alphanumeric data and responses to questions presented within the user interface;
presenting within the user interface an interview comprising a set of questions that are based on a set of requirements of at least one government regulation;
generating, based on responses to the set of questions received from the at least one user, a decision on whether to grant a government-provided benefit to a potential recipient of said benefit; and
updating a database with the responses provided by the user.

2. The medium of claim 1, wherein the benefit is subsidized modification of housing to accommodate a disabled individual.

3. The medium of claim 1, wherein the method further comprises the step of disabling the user from altering the set of questions.

4. The medium of claim 1, wherein the method further comprises the step of enabling the user to add at least one question to the set of questions.

5. The medium of claim 1, wherein the decision to grant is based on responses to the set of questions received from multiple users.

6. The medium of claim 1, wherein the method further comprises the step of presenting within the user interface, in response to the generation of a decision to not grant the benefit, at least one suggestion of an action that may be taken to achieve a decision to grant the benefit.

7. The medium of claim 1, wherein the method further comprises the step of automatically generating a document addressed to the potential recipient of the benefit describing the generated decision on whether to grant.

8. The medium of claim 5, wherein the method further comprises the step of generating notifications at a predetermined frequency to the multiple users reminding the users to provide their responses to the set of questions.

9. A system, comprising:
at least one processor; and
at least one storage device in communication with the at least one processor, the at least one storage device including instructions that, when executed by the at least one processor, enable the performance of a method comprising the steps of:
generating to a display device a graphical user interface comprising elements enabling at least one user to enter alphanumeric data and responses to questions presented within the user interface;
presenting within the user interface an interview comprising a set of questions that are based on a set of requirements of at least one government regulation;
generating, based on responses to the set of questions received from the at least one user, a decision on whether to grant a government-provided benefit to a potential recipient of said benefit; and
updating a database with the responses provided by the user.

10. The system of claim 9, wherein the benefit is subsidized modification of housing to accommodate a disabled individual.

11. The system of claim 9, wherein the method further comprises the step of disabling the user from altering the set of questions.

12. The system of claim 9, wherein the method further comprises the step of enabling the user to add at least one question to the set of questions.

13. The system of claim 9, wherein the decision to grant is based on responses to the set of questions received from multiple users.

14. The system of claim 9, wherein the method further comprises the step of presenting within the user interface, in response to the generation of a decision to not grant the benefit, at least one suggestion of an action that may be taken to achieve a decision to grant the benefit.

15. The system of claim 9, wherein the method further comprises the step of automatically generating a document addressed to the potential recipient of the benefit describing the generated decision on whether to grant.

16. The system of claim 13, wherein the method further comprises the step of generating notifications at a predetermined frequency to the multiple users reminding the users to provide their responses to the set of questions.
